(19) United States
(12) Patent Application Publication
(10) Pub. No.: US 2016/0066254 A1
(43) Pub. Date: Mar. 3, 2016

(54) Method and system for smart door directionality detection

(71) Applicant: INTEL CORPORATION, Santa Clara, CA (US)

(72) Inventors: Robert A. Colby, Granite Bay, CA (US); Jason Martin, Beaverton, OR (US); Ramune Nagisetty, Portland, OR (US); Mats G. Agerstam, Portland, OR (US)

(21) Appl. No.: 14/594,719

(22) Filed: Jan. 12, 2015

Related U.S. Application Data
(60) Provisional application No. 62/044,933, filed on Sep. 2, 2014.

(51) Int. Cl. H04W 48/16; H04W 4/02

(52) U.S. Cl. CPC H04W 48/16; H04W 4/026; H04W 88/06

(57) ABSTRACT

Disclosed herein are directionality detection techniques for smart door locks. According to various such techniques, a smart door lock may be configured to transmit an inside chirp on a private side of a door and an outside chirp on a public side of the door. The inside and outside chirps may comprise wireless signals of a type that typically does not penetrate walls, doors, and/or other barriers. In some embodiments, such directionality detection techniques may be utilized in combination with device discovery procedures performed according to a low-power wireless discovery protocol such as Bluetooth® Low Energy (BLE) or Neighbor Awareness Networking (NAN).

The instant application claims the filing date priority to the Provisional Patent Application No. 62/044,933, filed Sep. 2, 2014, the disclosure of which is incorporated herein in its entirety.

### BACKGROUND

1. Field

The disclosure relates to a method, apparatus and system to detect directionality of a smart key communicating with a smart door. Specifically, the disclosed embodiments provide a method, apparatus and system to detect location of a wireless smart key relative to a smart door lock and to engage or to disengage the lock in accordance with the detected location.

2. Description of Related Art

One growing area of focus in the market for smart home/building solutions is the smart door lock. Generally speaking, a smart door lock has wireless communication capabilities and can be configured to automatically unlock when a corresponding smart door key is detected within a certain proximity of the lock. In many cases, it may be desirable that triggering of the automatic unlocking capability of a smart door lock be dependent not only on the proximity of the smart door key but also on the directionality of the smart door key. For example, given that the smart door key is detected within a required proximity of the smart door lock, it may be desirable that automatic unlocking be triggered only if the smart door key is positioned on the outdoor/public side of the door. One drawback associated with conventional smart door systems is that the techniques implemented to detect smart door key directionality are inaccurate and unreliable.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 illustrates an embodiment of an operating environment;

FIG. 2 illustrates an operational flow of a method according to one embodiment of the disclosure;

FIG. 3 illustrates an embodiment of a device; and

FIG. 4 shows an exemplary timing sequence for an exemplary embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec., 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

In certain embodiments, the disclosure relates to a method for providing security access to a smart device. The smart device may include a smart key and a smart lock. The key may include any device capable of transmitting and receiving signals. The signals may be any of BT/BLE, Neighbor Awareness Networking (NAN), Wi-Fi, cellular, ultrasound or other signals. The smart lock may include any device capable of securing access to a location, data file or other tangible or intangible objects. A smart lock, my include, a conventional lock configured for wireless activation/deactivation, a vehicle door lock, a vehicle ignition and a computer access point.

In one implementation, a smart lock determines presence of a smart key. The smart key may be proximal to the smart lock such that the smart key and the smart lock may detect signals transmitted from each other. Once proximity is detected, additional algorithm may be implemented to locate the smart key relative to the smart device and to determine whether the smart lock may be grant security access. It should be noted that while the exemplary embodiments disclosed herein are directed to smart key and lock system, the disclosed principles are not limited thereto and may applied to any securing mechanism including computers, vehicles and the like.

In another embodiment, the disclosure relates to directionality detection techniques for smart locking devices. According to certain embodiments, a smart door lock may be configured to transmit an inside chirp (or indication) on a private side of a door and an outside chirp on a public side of the door. The inside and outside chirps may comprise wireless signals of a type that typically does not penetrate walls, doors and/or other barriers. In some embodiments, such directionality detection techniques may be utilized in combination with device discovery procedures performed according to a low-power wireless discovery protocol such as BT, BLE or NAN.

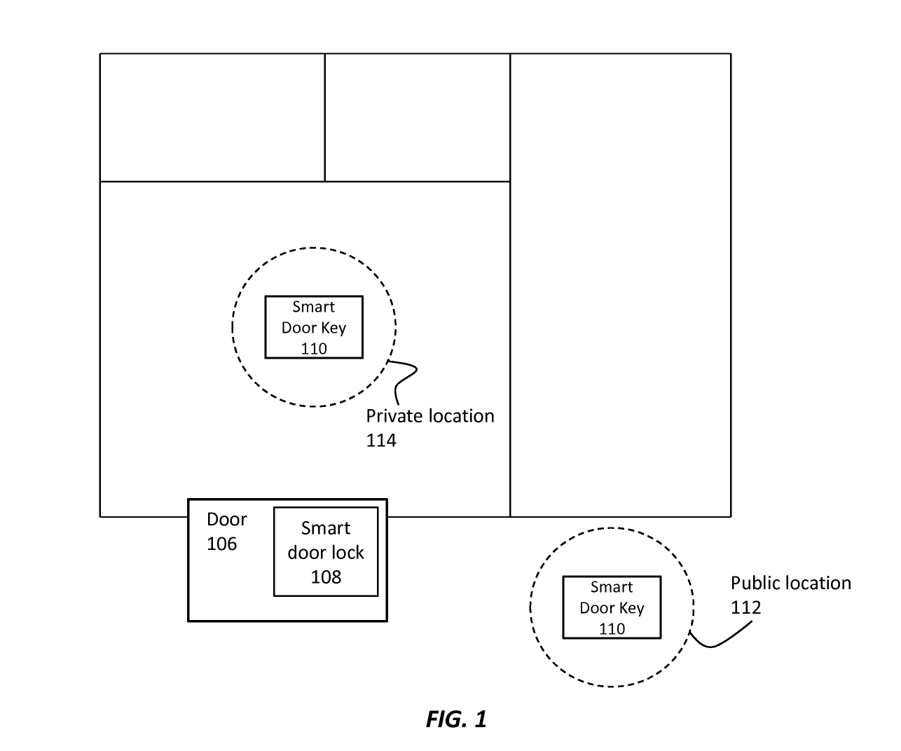

FIG. 1 illustrates an example of an operating environment 100 such as may be representative of various embodiments. In operating environment 100, access may be obtained from a public area 102 to a private area 104 through a door 106. In some embodiments, private area 104 may comprise a home, an office, a store, or another type of residential or non-residential building, an enclosure such as a shed or greenhouse, or another type of structure, and public area 102 may comprise an outdoor area such as may comprise/contain a porch, a sidewalk, a yard, a street, a pedestrian walkway, or other public outdoor feature. In various other embodiments, private area 104 may comprise a room/region within a home, office, store, building, enclosure, or other type of structure, and public area 102 may comprise a publicly-accessible room/region within that home, office, store, building, enclosure, or other type of structure, or a region accessible to persons not authorized to enter private area 104.

In operating environment 100, door 106 may be equipped with a smart door lock 108 configured to automatically unlock based on the presence of a smart door key 110. Examples of smart door key 110 may include, without limitation, a key fob, a mobile communications device such as a cellular phone, a wireless-enabled wearable device, or another type of device with wireless communication capabilities. In order to detect the presence of smart door key 110, smart door lock 108 may be operative to wirelessly communicate with smart door key 110. In some embodiments, smart door lock 108 may wirelessly communicate with smart door key 110 according to one or more wireless communication standards/techniques supporting low-power discovery, such as BLE or NAN low-power discovery techniques. In various embodiments, it may be possible for smart door lock 108 to determine or estimate the proximity of smart door key 110 to door 106 in conjunction with communicating with smart door key 110 according to such wireless communication standards/techniques. For example, if smart door lock 108 and smart door key 110 discover each other via BLE device discovery procedures, it may be possible for smart door lock 108 to determine or estimate the proximity of smart door key 110 to door 106 based on received signal strength indicators (RSSIs) for one or more BLE messages exchanged between smart door lock 108 and smart door key 110.

In operating environment 100, whether it is desirable that smart door lock 108 be automatically unlocked may depend not only on the proximity of smart door key 110 to smart door lock 108 but also on whether smart door key 110 is located on the public side or the private side of door 106. If smart door key is positioned at a public location 112 on the public side of door 106, this may indicate that a person possessing smart door key 110 (a “key-holder”) has approached the public side of door 106, and it may thus be desirable that smart door lock 108 be automatically unlocked. If smart door key 110 is positioned at a private location 114 on the private side of door 106, this may indicate that a key-holder who has already entered private area 104 has approached the private side of door 106. However, the fact that the key-holder has approached the private side of door 106 may not necessarily indicate that the key-holder intends to exit private area 104. For example, the key-holder may have approached the private side of door 106 in order to respond to a knock on door 106, and it may be desirable that smart door lock 108 remain locked in the interest of the safety of the key-holder and/or the security of private area 104. As such, if smart door key 110 is positioned at private location 114 on the private side of door 106, it may not be desirable that smart door lock 108 be automatically unlocked.

The conventional methods determine directionality based on RSSI measurements for the signals exchanged between the smart door lock and the smart door key. Typical RSSI measurements include low-power discovery protocols such as BLE or NAN. However, the use of RSSIs of wireless communications performed according to such low-power discovery protocols is unreliable and results in frequent false positives and/or false negatives. One factor contributing to this unreliability in many cases may be the relative ease with which wireless signals transmitted according to such protocols are able to pass through walls, doors and/or other barriers that may form parts of the boundary between the areas on respective sides of a door equipped with a smart door lock.

According to the directionality detection embodiments disclosed herein, this shortcoming may be addressed by combining low-power wireless discovery according to a protocol such as BLE or NAN with a directionality detection procedure that utilizes non-penetrating wireless signals. As used herein, the term non-penetrating wireless signal generally denotes a wireless signal of a type that typically does not pass through walls, doors and/or other barriers that may form parts of the boundary between the areas on respective sides of a door equipped with a smart door lock.

In some embodiments, the directionality detection procedure may involve the use of non-penetrating wireless signals that comprise signals transmitted over carrier frequencies that typically do not penetrate such walls doors, and/or other barriers. For example, in certain embodiments, the directionality detection procedure may involve wireless communications over one or more carriers of a 30-300 GHz millimeter wave (mmWave) frequency band. This range is exemplary and the disclosed principles are not limited thereto.

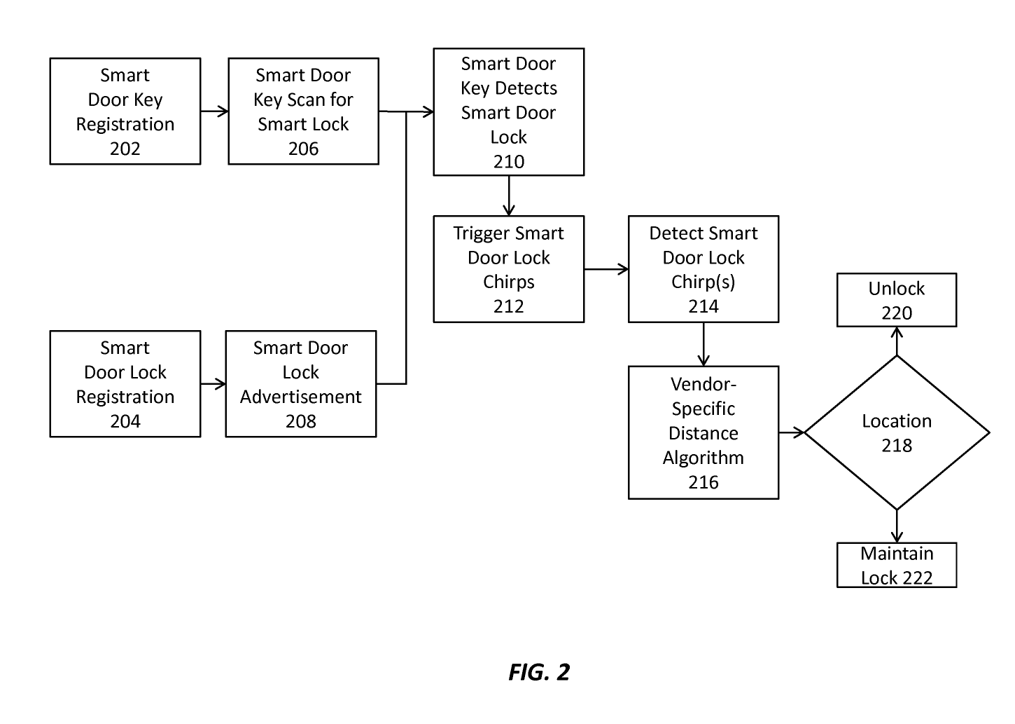

FIG. 2 illustrates an operational flow 200 according to one embodiment of the disclosure. More particularly, operational flow 200 may be representative of various embodiments in which low-power wireless discovery according to a protocol such as BLE or NAN is combined with a directionality detection procedure that involves the transmission of one or more smart door lock chirps that comprise non-penetrating wireless signals and that enable a smart door key to determine whether it is located on the public side of a door featuring a smart door lock. As shown in operational flow 200, at steps 202 and 204 respectively, registration may be performed for a smart door key and a smart door lock. At steps 206 and 208, respectively, the smart door key may scan for the smart door lock and the smart door lock may advertise itself according to applicable low— power wireless discovery protocols. At step 210, the smart door key may detect the smart door lock based on one or more advertisement messages transmitted by the smart door lock.

At step 212, in response to detection of the smart door lock, the smart door key may trigger a set of smart door lock chirps. In some embodiments, each smart door lock chirp may comprise a non-penetrating wireless signal. In various embodiments, each smart door lock chirp may be transmitted via a non-penetrating wireless carrier, such as a wireless carrier of an mmWave frequency band. In some embodiments, the set of smart door lock chirps may comprise an inside chirp and an outside chirp. In various embodiments, the inside chirp and the outside chirp may comprise distinctive patterns that differ from each other. In some embodiments, the inside chirp may be transmitted via an antenna positioned on the private side of the smart door lock. In certain embodiments, the inside chirp may propagate within the area on the private side of the smart door lock but may not penetrate into the area on the public side of the smart door lock. In some embodiments, the outside chirp may be transmitted via an antenna positioned on the public side of the smart door lock. In various embodiments, the outside chirp may propagate within the area on the public side of the smart door lock, but may not penetrate into the area on the private side of the smart door lock.

At step 214, the smart door key may detect the inside chirp, the outside chirp, or both, and may wirelessly communicate with the smart door lock in order to identify the detected chirp(s). In some embodiments, detection of both the inside chirp and the outside chirp may indicate that the door containing the smart door lock is open. At step 216, the smart door lock may utilize one or more vendor-specific distance algorithms in order to estimate the proximity of the smart door key to the smart door lock. At step 218, the smart door lock may determine whether the smart door key is located on the public side of the door, based on the detected chirp(s). If the outside chirp is detected but the inside chirp is not detected, the smart door lock may determine that the smart door key is located on the public side of the door, and may unlock the door at step 220. If the inside chirp is detected but the outside chirp is not detected, the smart door lock may determine that the smart door key is located on the private side of the door, and flow may pass to step 222, where the current state of the smart door lock may be maintained. If both the outside chirp and the inside chirp are detected, the smart door lock may determine that the door is open, and flow may pass to step 222, where the current state of the smart door lock may be maintained. In some embodiments, the smart door lock's ability to detect that the door is open may enable the smart door lock to replace functionality provided by door sensors in the so-called smart home systems. The exemplary embodiment of FIG. 2 may be implemented in hardware, software or a combination of hard ware and software.

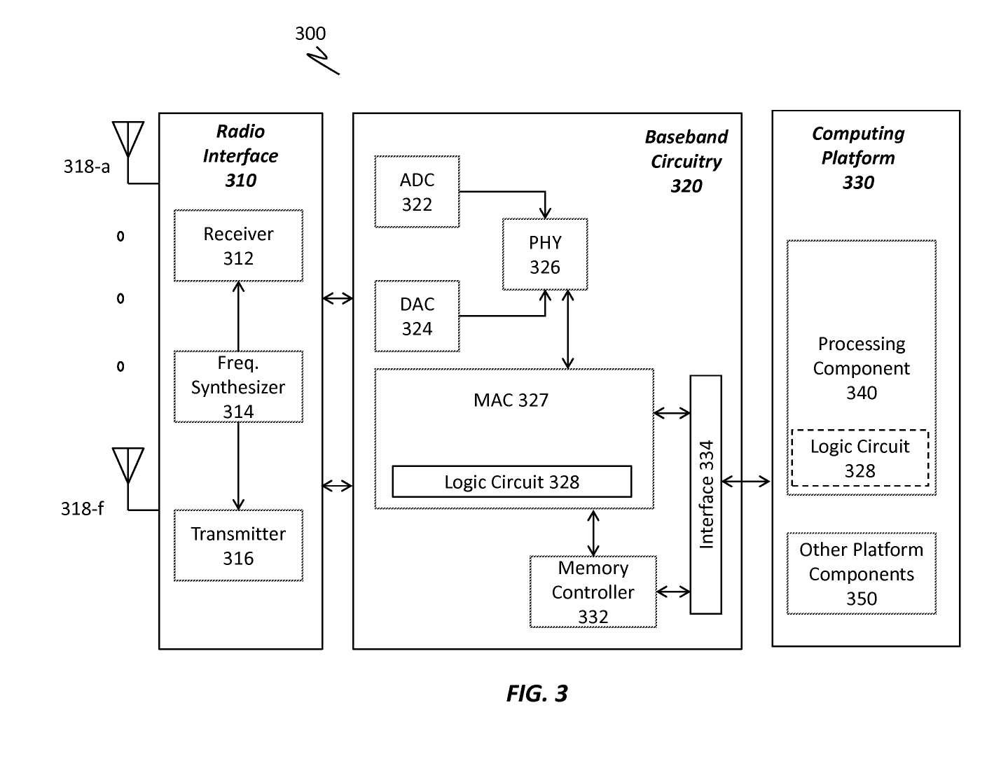

FIG. 3 illustrates an embodiment of a communications device 300 that may be representative of features of smart door lock 108 and/or smart door key 110 of FIG. 1. In various embodiments, communications device 300 may be configured to perform one or more operations comprised in operational flow 200 of FIG. 2. In certain embodiments, device 300 may comprise one or more logic circuits 328. The logic circuit 328 may include physical circuits to perform, among others, operations described for operational flow 200 of FIG. 2.

As shown in FIG. 3, device 300 may include a radio interface 310, baseband circuitry 320, and computing platform 330, although the embodiments are not limited to this configuration. Device 300 may implement some or all of the structure and/or operations for one or more of smart door lock 108 and/or smart door key 110 of FIG. 1, and/or operational flow 200 of FIG. 2 in a single computing entity, such as entirely within a single device. Alternatively, device 300 may distribute portions of the structure and/or operations for one or more of smart door lock 108 and/or smart door key 110 of FIG. 1, and/or operational flow 200 of FIG. 2 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture and other types of distributed systems. The disclosed embodiments are not limited to these examples.

In one embodiment, radio interface 310 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 310 may include, for example, a receiver 312, a frequency synthesizer 314 and/or a transmitter 316. Radio interface 310 may include bias controls, a crystal oscillator and/or one or more antennas 318-a through f. In another embodiment, radio interface 310 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 320 may communicate with radio interface 310 to process receive and/or transmit signals and may include, for example, an analog-to-digital converter 322 for down converting received signals, a digital-to-analog converter 324 for up converting signals for transmission. Further, baseband circuitry 320 may include a baseband or physical layer (PHY) processing circuit 326 for PHY link layer processing of respective receive/transmit signals. Baseband circuitry 320 may include, for example, a medium access control (MAC) processing circuit 327 for MAC/data link layer processing. Baseband circuitry 320 may include a memory controller 332 for communicating with MAC processing circuit 327 and/or a computing platform 330, for example, via one or more interfaces 334.

In some embodiments, PHY processing circuit 326 may include a frame construction and/or detection module, in combination with additional circuitry such as a buffer memory, to construct and/or deconstruct communication frames. Alternatively or in addition, MAC processing circuit 327 may share processing for certain of these functions or perform these processes independent of PHY processing circuit 326. In some embodiments, MAC and PHY processing may be integrated into a single circuit.

The computing platform 330 may provide computing functionality for the device 300. As shown, the computing platform 330 may include a processing component 340. In addition to, or alternatively of, the baseband circuitry 320, the device 300 may execute processing operations or logic for one or more of smart door lock 108 and/or smart door key 110 of FIG. 1 and/or operational flow 200 of FIG. 2 using the processing component 340.

The processing component 340 (and/or PHY 326 and/or MAC 327) may comprise various hardware elements, software elements or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 330 may further include other platform components 350. Other platform components 350 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 300 may be, for example, an ultra-mobile device, a mobile device, a fixed device, a machine-to-machine (M2M) device, a personal PDA, a mobile computing device, a smart phone, a telephone, a digital telephone, a cellular telephone, user equipment, eBook readers, a handset, a one-way pager, a two-way pager, a messaging device, a computer, a PC, a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 300 described herein, may be included or omitted in various embodiments of device 300, as suitably desired.

Embodiments of device 300 may be implemented using single input single output (SISO) architectures. However, certain implementations may include multiple antennas (e.g., antennas 318 a-f) for transmission and/or reception using adaptive antenna techniques for beamforming or spatial division multiple access (SDMA) and/or using MIMO communication techniques.

The components and features of device 300 may be implemented using any combination of discrete circuitry, application specific integrated circuits (ASICs), logic gates and/or single chip architectures. Further, the features of device 300 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 300 shown in the block diagram of FIG. 3 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

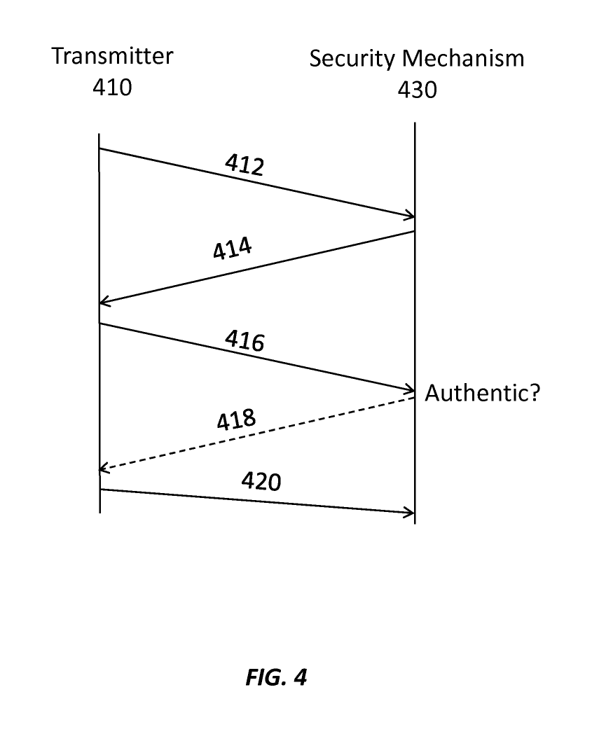

FIG. 4 shows an exemplary timing sequence for an exemplary embodiment of the disclosure. In the timing sequence of FIG. 4, transmitter 410 may be a smart key, a fob, a transponder or any other security device configured to transmit (and optionally receive) a signal. Security mechanism 430 may be a smart lock or any other security device capable of wireless communication. The exemplary process of FIG. 4 starts with transmitter 410 sending a first indication 412 to security mechanism 430. The first indication 412 may be a low-power device signal such as a BT/BLE advertisement configured for proximity detection. While FIG. 4 shows the first indication transmitted by transmitter 410, the process may equally be initiated by security mechanism 430.

In response to the first indication 412, security mechanism may conduct a query 414 to authenticate transmitter 410. The authentication step 414 may be optional. The authentication step 414 may be implemented to ensure transmitter 412 may access the premises or files secured by security mechanism 430. Transmitter 410 may respond to query 414 by providing authentication information. If the authentication information validates transmitter's authenticity (step 416), the process continues. At optional step 418 security mechanism 430 may issue a location detection (e.g., directionality detection) indication. While not shown, the location detection indication may also be issued by transmitter 410 and received by security mechanism 430. In one embodiment, the location detection indication 420 may be an ultrasound signal or other signal not penetrable through a physical barrier such as a will or a window. Transmitter 420 may transmit location detection indication 420 without being prompted by signal 418. Alternatively, the location detection indication 420 may be issued by security mechanism 430 and transmitter 410 may issue an acknowledgment (not shown) indicting receipt thereof and provide access to transmitter 410.

The following exemplary and non-limiting embodiments are provided to further illustrate various implementations of the disclosure. Example 1 is directed to a security mechanism comprising one or more processors and circuitry, the circuitry including: a first logic to discover a proximal device through low-power discovery by sending and/or receiving a first signal or a first communication mode; a second logic to determine directionality of the proximal device by sending and/or receiving a second signal of a second communication mode; and a third logic to determine whether to grant access to the proximal device as a function of a location and directionality of the proximal device.

Example 2 is directed to the security mechanism of example 1, wherein the first communication mode is BT/BLE and the second communication mode is ultrasonic.

Example 3 is directed to the security mechanism of example 2, wherein the second signal does not penetrate a physical barrier.

Example 4 is directed to the security mechanism of example 1, wherein the first mechanism is further configured to authenticate the proximal device.

Example 5 is directed to the security mechanism of example 1, wherein the third logic grants access to the proximal device when the proximal device approaches a secured zone protected by the security mechanism.

Example 6 is directed to the security mechanism of example 1, wherein third logic is further configured to change a security state when the proximal device is inside the secured zone.

Example 7 is directed to the security mechanism of example 6, wherein the third logic denies access to the proximal device when the directionality of the proximal device indicates movement away from a secured zone.

Example 8 is directed to a tangible machine-readable non-transitory storage medium that contains instructions, which when executed by one or more processors result in performing operations comprising: discovering a proximal device through low-power discovery by sending and/or receiving a first signal or a first communication mode; determining directionality of the proximal device by sending and/or receiving a second signal of a second communication mode; and determining whether to grant access to the proximal device as a function of a location and directionality of the proximal device.

Example 9 is directed to the tangible machine-readable non-transitory storage medium of example 8, wherein the first communication mode is BT/BLE and the second communication mode is ultrasonic.

Example 10 is directed to the tangible machine-readable non-transitory storage medium of example 8, wherein the second signal does not penetrate a physical barrier.

Example 11 is directed to the tangible machine-readable non-transitory storage medium of example 8, wherein the instructions further comprise authenticating the proximal device.

Example 12 is directed to the tangible machine-readable non-transitory storage medium of example 8, wherein the instructions further comprise granting access to the proximal device when the proximal device approaches a secured zone protected by the security mechanism.

Example 13 is directed to the tangible machine-readable non-transitory storage medium of example 8, wherein the instructions further comprise denying access to the proximal device when the directionality of the proximal device indicates movement away from a secured zone.

Example 14 is directed to the tangible machine-readable non-transitory storage medium of example 8, wherein the instructions further comprise changing a security state when the proximal device is inside the secured zone.

Example 15 is directed to a method to provide security access to a secured zone, the method comprising: discovering a proximal device seeking access by sending and/or receiving a first signal or a BT/BLE signal; determining directionality of the proximal device by sending and/or receiving an ultrasonic signal; and determining whether to grant access to the proximal device as a function of a location and directionality of the proximal device.

Example 16 is directed to the security mechanism of example 15, further comprising granting access when both the BT/BLE and the ultrasonic signals have been received.

Example 17 is directed to the security mechanism of example 15, wherein the BT/BLE signal is further configured to authenticate the proximal device.

Example 18 is directed to the security mechanism of example 15, further comprising changing a security state when the proximal device is inside the secured zone.

Example 19 is directed to the security mechanism of example 18, further comprising changing the security state when the directionality of the proximal device indicates movement away from a secured zone.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used. While the principles of the disclosure have been illustrated in relation to the exemplary embodiments shown herein, the principles of the disclosure are not limited thereto and include any modification, variation or permutation thereof.

What is claimed is:

1. A security mechanism comprising one or more processors and circuitry, the circuitry including:
a first logic to discover a proximal device through low-power discovery by sending and/or receiving a first signal or a first communication mode;
a second logic to determine directionality of the proximal device by sending and/or receiving a second signal of a second communication mode; and
a third logic to determine whether to grant access to the proximal device as a function of at least a location and directionality of the proximal device.

2. The security mechanism of claim 1, wherein the first communication mode is BT/BLE and the second communication mode is ultrasonic.

3. The security mechanism of claim 2, wherein the second signal does not penetrate a physical barrier.

4. The security mechanism of claim 1, wherein the first mechanism is further configured to authenticate the proximal device.

5. The security mechanism of claim 1, wherein the third logic grants access to the proximal device when the proximal device approaches a secured zone protected by the security mechanism.

6. The security mechanism of claim 1, wherein third logic is further configured to change a security state when the proximal device is inside the secured zone.

7. The security mechanism of claim 6, wherein the third logic denies access to the proximal device when the directionality of the proximal device indicates movement away from a secured zone.

8. A tangible machine-readable non-transitory storage medium that contains instructions, which when executed by one or more processors result in performing operations comprising:
discovering a proximal device through low-power discovery by sending and/or receiving a first signal or a first communication mode;
determining directionality of the proximal device by sending and/or receiving a second signal of a second communication mode; and
determining whether to grant access to the proximal device as a function of at least a location and directionality of the proximal device.

9. The tangible machine-readable non-transitory storage medium of claim 8, wherein the first communication mode is BT/BLE and the second communication mode is ultrasonic.

10. The tangible machine-readable non-transitory storage medium of claim 8, wherein the second signal does not penetrate a physical barrier.

11. The tangible machine-readable non-transitory storage medium of claim 8, wherein the instructions further comprise authenticating the proximal device.

12. The tangible machine-readable non-transitory storage medium of claim 8, wherein the instructions further comprise granting access to the proximal device when the proximal device approaches a secured zone protected by the security mechanism.

13. The tangible machine-readable non-transitory storage medium of claim 8, wherein the instructions further comprise denying access to the proximal device when the directionality of the proximal device indicates movement away from a secured zone.

14. The tangible machine-readable non-transitory storage medium of claim 8, wherein the instructions further comprise changing a security state when the proximal device is inside the secured zone.

15. A method to provide security access to a secured zone, the method comprising:
discovering a proximal device seeking access by sending and/or receiving a first signal or a BT/BLE signal;
determining directionality of the proximal device by sending and/or receiving an ultrasonic signal; and
determining whether to grant access to the proximal device as a function of at east a location and directionality of the proximal device.

16. The method of claim 15, further comprising granting access when both the BT/BLE and the ultrasonic signals have been received.

17. The method of claim 15, wherein the BT/BLE signal is further configured to authenticate the proximal device.

18. The method of claim 15, further comprising changing a security state when the proximal device is inside the secured zone.

19. The method of claim 18, further comprising changing the security state when the directionality of the proximal device indicates movement away from a secured zone.
